(19) United States
(12) Patent Application Publication
(10) Pub. No.: US 2019/0111767 A1
(43) Pub. Date: Apr. 18, 2019

(54) Oxygen Dispensing System for a Passenger Cabin

(71) Applicant: Hazim Abdulzahra, Lake Elsinore, CA (US)

(72) Inventor: Hazim Abdulzahra, Lake Elsinore, CA (US)

(21) Appl. No.: 15/783,911

(22) Filed: Oct. 13, 2017

(51) Int. Cl. B60H 3/00

(52) U.S. Cl. CPC B60H 3/0014; B60H 3/0035

(57) ABSTRACT

A system for providing oxygen in a vehicle passenger cabin, the system comprising a gaseous oxygen source, a duct for connection to at least one vent for passage of oxygen to the passenger cabin, the duct being coupled to the oxygen source for passage of oxygen from the oxygen source to the vent, a regulator for regulating passage of oxygen from the oxygen source, a controller coupled to the regulator for controlling the regulator, and an oxygen sensor within the passenger cabin for sensing the amount of oxygen in the passenger cabin.

### BACKGROUND

Drivers of vehicles can experience stress, restlessness, and lethargy. All of these symptoms increase the risk of an accident while driving. Additionally, many countries suffer from severe dust storms that can affect air quality. Accordingly, there is a need for a system for reducing these symptoms and maintaining air quality.

### SUMMARY

In one embodiment, the present invention is directed to a system for providing oxygen in a vehicle passenger cabin, the system comprising a) a gaseous oxygen source; b) a duct for connection to at least one vent for passage of oxygen to the passenger cabin, the duct being coupled to the oxygen source for passage of oxygen from the oxygen source to the vent; c) a regulator for regulating passage of oxygen from the oxygen source; d) a controller coupled to the regulator for controlling the regulator; and e) an oxygen sensor within the passenger cabin and for coupling to the controller for controlling the amount of gas released by the regulator from the oxygen source for passage into the passenger cabin.

The gaseous oxygen source is a container containing a gas of which at least 90% by volume is oxygen. Optionally, the gaseous oxygen source is an oxygen generating device.

When the system is installed in the vehicle comprising two vents, one vent proximate a driver position and one vent proximate a passenger position, wherein the duct is in gaseous communication with both vents for passage of oxygen from the gaseous oxygen source into the vehicle passenger cabin. The regulator is a valve located in the duct.

Optionally, the regulator is an off-on regulator, such that when a pre-set lower oxygen level is sensed by the oxygen sensor, the oxygen sensor causes the controller to have the regulator dispense oxygen from the gaseous oxygen source, and when a pre-set upper oxygen level is sensed by the oxygen sensor, the oxygen sensor causes the controller to have the regulator stop dispensing oxygen from the gaseous oxygen source.

Additionally, a user can set the pre-set lower oxygen level and the pre-set upper oxygen level using the controller. Optionally, the oxygen sensor has a pre-set lower oxygen level and senses a passenger cabin oxygen level, and the controller is a proportional controller. The controller is electrically, pneumatically or wirelessly coupled to the regulator. Optionally, a user can cause the regulator to dispense oxygen from the oxygen source.

The system can also comprise a smoke detector coupled to the regulator, wherein if the smoke detector detects smoke the smoke detector causes the regulator to stop dispensing oxygen from the oxygen source.

In a second embodiment, the present invention is directed to a system for providing oxygen in a vehicle passenger cabin, the system comprising: a) a vehicle having a passenger cabin, an engine compartment, and a trunk; b) a gaseous oxygen source coupled to the vehicle and not located in the passenger cabin; c) a duct connected to at least one vent in the passenger cabin, for passage of oxygen to the passenger cabin, the duct being coupled to the oxygen source for passage of oxygen from the oxygen source to the vent; d) a regulator for regulating passage of oxygen from the oxygen source; e) a controller coupled to the regulator for controlling the regulator; and f) an oxygen sensor within the passenger cabin and coupled to the controller for controlling the amount of gas released by the regulator from the oxygen source for passage into the passenger cabin.

Optionally, the gaseous oxygen source is located in the engine compartment or the trunk.

### DRAWINGS

These and other features, aspects, and advantages of the present invention will become better understood with reference to the following description, appended claims, and accompanying drawings where:

FIG. 1 is a schematic perspective view of a system for providing oxygen in a vehicle passenger cabin having features of the present invention, wherein a gaseous oxygen source is in a container; and

FIG. 2 is another schematic perspective view of the system of FIG. 1, wherein the gaseous oxygen source is an oxygen generating machine.

### DESCRIPTION

As used herein, the following terms and variations thereof have the meanings given below, unless a different meaning is clearly intended by the contest in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

As used herein, a “controller” is something that directs or regulates something, such as, for example, a regulator. A controller can be used in connection with software that directs the controller's function. A controller can include memory such as a random access memory chip. A controller can be a microcontroller (or MCU for microcontroller unit) that contains one or more CPU cores, and may include memory and programmable input/output peripherals or a similar programmable controller on a single integrated circuit, including a system on a chip or SoC, or state machine.

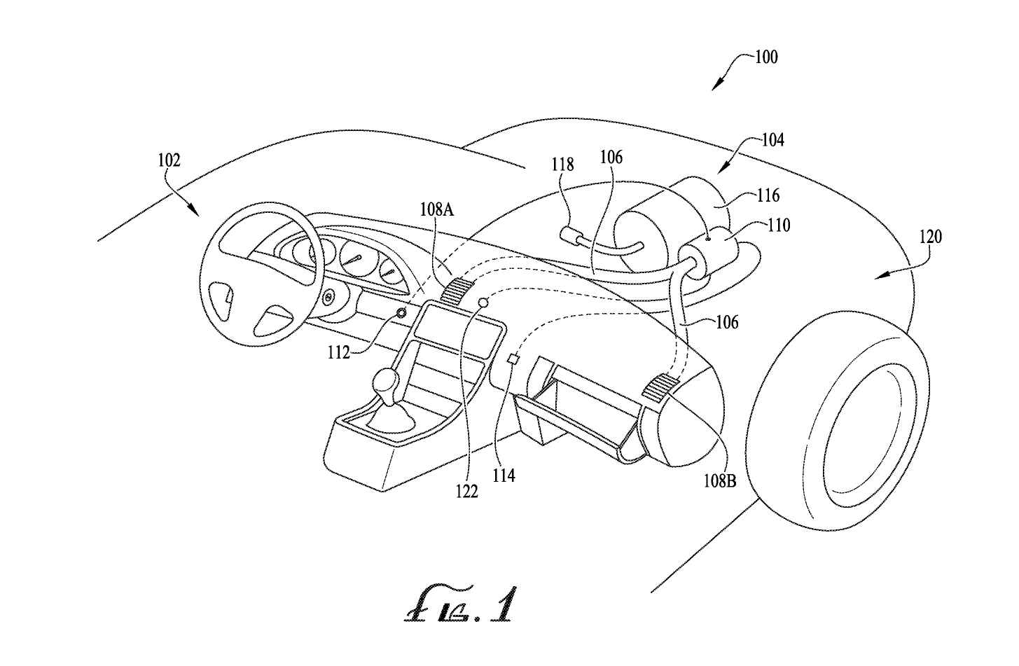

Referring now to FIG. 1, there is shown a system 100 for providing oxygen in a vehicle passenger cabin 102. The system 100 comprises a gaseous oxygen source 104, at least one duct 106 for connection to at least one vent 108 for passage of oxygen to the passenger cabin 102, a regulator 110 for regulating passage of oxygen from the oxygen source 104, a controller 112 coupled to the regulator 110 for controlling the regulator 110, and an oxygen sensor 114 for mounting within the passenger cabin 102 and for coupling to the regulator 110 for controlling the amount of gas released from the oxygen source 104 for passage into the passenger cabin 102.

In a version of the system 100 shown in FIG. 1, the gaseous oxygen source 104 is a container 116 containing a gas of which at least 90% by volume is oxygen. A recharge valve 118 is coupled to the container 116 such that the container 116 can be filled and refilled with oxygen as necessary. The container 116 can contain either compressed oxygen or liquid oxygen. Typical oxygen containers are made from aluminum, come in a cylinder shape and a variety of sizes depending on the application.

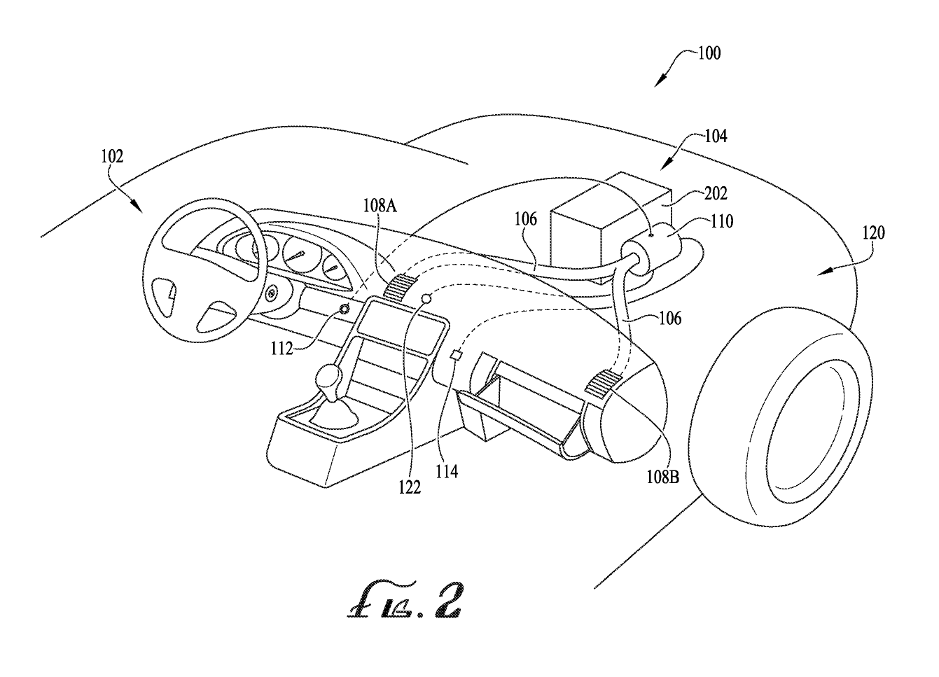

In a version of the system 100 shown in FIG. 2, the gaseous oxygen source 104 is an oxygen generating machine 202. The oxygen generating machine 202 is coupled to a power source, typically an automotive battery. The oxygen generating machine 202, or oxygen concentrator, is a device which concentrates oxygen from a gas supply (typically ambient air) to supply an oxygen-enriched gas stream. It works by taking in air from its surroundings, compressing the air while a cooling mechanism keeps the concentrator from overheating, removing nitrogen from the air via filter and sieve beds, and delivering the purified oxygen. The purified oxygen stream is typically at least 90% by volume oxygen, although the oxygen generating machine 202 can be adjusted to deliver any desired concentration of oxygen. For example, the Inogen One G4 System (Mogen, Goleta, Calif.) provides a steady source of approximately 99% oxygen for its user.

In either version, when the system 100 is installed in a vehicle having a passenger cabin 102, and typically an engine compartment 120 and trunk, the gaseous oxygen source 104 is typically not located in the passenger cabin 102, preferably being located in either the engine compartment 120 or the trunk of the vehicle. The location of the oxygen source 104 outside the passenger cabin 102 is desirable because in the event of an accident, the driver and passengers are shielded from any harm caused by a damaged gaseous oxygen source 104. Additionally, if the oxygen source 104 is an oxygen generating machine 202, it may produce some noise, in which case it is desirable to shield the driver and passengers from such noise. However, the gaseous oxygen source 104 can be located in the passenger cabin 102 if desired, for example, for ease of access by the user.

The at least one duct 106 is for connection to at least one vent 108 in the passenger cabin 102, for passage of oxygen to the passenger cabin 102. The duct 106 is coupled to the oxygen source 104 for passage of oxygen from the oxygen source 104 to the vent 108. The duct 106 can be made from a flexible, plastic material, so that it is easy to install and secure to the vents 108 in the passenger cabin 102. Optionally, system 100 can utilize the already existing air ducts installed in the vehicle for the air conditioning system, and thus the duct 106 is not an additional element.

When the system 100 is installed in the vehicle, the system 100 comprises at least one vent proximate a driver position 108A. Optionally, the system 100 comprises two vents, one vent proximate the driver position 108A and one vent proximate a passenger position 108B. In both instances, one or more ducts 106 are in gaseous communication with one or both vents 108A, 108B for passage of oxygen from the gaseous oxygen source 104 into the vehicle passenger cabin 102. The system 100 can utilize the already existing air vents installed in the vehicle for the air conditioning system, and thus the vent is not an additional element.

The regulator 110 regulates release of oxygen from the gaseous oxygen source 104. The regulator 110 can be coupled to the gaseous oxygen source 110, or the regulator 110 is a valve located somewhere in the duct 106. In the event the system 100 utilizes the already existing air ducts installed in the vehicle for the air conditioning system, the regulator 110 can be coupled to the existing ducts, utilizing them to dispense oxygen to the passenger cabin 102.

The controller 112 is coupled to the regulator 110 for controlling the regulator 110. A desired set point can be set with the controller 112 such as 21% oxygen in the vehicle passenger cabin 102. The controller 112 is electrically, pneumatically, or wirelessly coupled to the regulator 110. The controller 112 can be a button, dial or interactive computer screen mounted in the passenger cabin 102, or the controller 112 is an application on a user's mobile device that is wirelessly coupled via Bluetooth to the regulator 110. Optionally, the controller 112 may be contained within a wireless infrared remote that the user can use to control the regulator 110. The user can use the controller 112 to set the desired set point, to cause the regulator 110 to release a specific amount of oxygen, or simply turn the regulator on or off, starting or stopping the flow of oxygen as desired. The controller 112 can automatically turn the regulator 110 on or off in response to input received from the sensor 114. The controller 112 can be associated with software that enables the regulation of the regulator 110 automatically in response to input from the sensor 114. The software can cause the regulator 110 to open and close depending on the input from the sensor 114. The software can be stored in memory of the controller 112. A conventional device controller receives data and stores it temporarily in some special purpose registers (i.e. local buffer) inside the controller 112. Then it communicates the data with a driver.

The controller 112 can have a variety of power sources. If the controller 112 is coupled to the vehicle, the controller's 112 power source is typically the automotive battery. If the controller 112 is contained within a wireless infrared remote control, the power source is typically smaller batteries, such as AA or AAA, and they can be rechargeable. If the controller 112 is an application on a smart phone or mobile device, the battery in the smart phone or mobile device is the power source for the controller 112.

The sensor 114 can be an oxygen sensor. In the embodiment illustrated in the Figures, the sensor 114 is within the passenger cabin 102 and coupled to the controller 112 for controlling the amount of gas released by the regulator 110 from the oxygen source 104 for passage into the passenger cabin 102. The sensor 114 can be mounted within the passenger cabin 102, or mounted outside the passenger cabin 102, such as in the engine compartment or trunk, and extend into the passenger cabin 102. The sensor 114 can be wire coupled, or wirelessly coupled to the controller 112, utilizing Bluetooth technology for example. The sensor 114 communicates a sensed value representative of the oxygen content of the air in the vehicle passenger cabin 102 and transmits the sensed content to the controller 112 which compares what is sensed against the desired set point. The controller 112 then controls the regulator 110 to allow more or less oxygen to flow into the vehicle passenger cabin 102 from the oxygen source 104. On-off control or proportional control can be used by the controller 112.

In one embodiment, the regulator 110 is an off-on regulator 110, such that when a pre-set lower oxygen level is sensed by the sensor 114, the controller 112 causes the regulator 110 to dispense oxygen from the oxygen source 104, and when a pre-set upper oxygen level is sensed by the sensor 114, the controller 112 causes the regulator 110 stop dispensing oxygen from the oxygen source 104. The user can set the pre-set lower oxygen level and the pre-set upper oxygen level, or a manufacturer can set the pre-set lower oxygen level and the pre-set upper oxygen level. In either case, the pre-set lower oxygen level is not lower than 19.5%, which OSHA (Occupational Safety and Health Administration) deems an oxygen deficient environment, and the pre-set upper oxygen level is not higher than 23.5%, which OSHA deems an oxygen-enriched atmosphere, and presents significant fire and explosion risk.

Optionally, the regulator 110 is a proportional regulator that dispenses a varying amount of oxygen in response to a difference between the pre-set lower oxygen level and a passenger cabin oxygen level. The proportional regulator 110 dispenses more oxygen when the difference between the passenger cabin oxygen level and the pre-set lower oxygen level is bigger, and dispenses less oxygen when the difference between the passenger cabin oxygen level and the pre-set lower oxygen level is smaller. This proportional regulation can be achieved by a valve in the regulator 110 opening wider when the difference is bigger and opening narrower when the difference is smaller.

A smoke detector 122 can be coupled to the regulator 110, so that if the smoke detector 122 detects smoke, the smoke detector 122 causes the regulator 110 to stop dispensing oxygen from the gaseous oxygen source 104. This provides a safety feature in the event a driver (or a passenger) decides to smoke cigarettes while the system 100 is dispensing oxygen. The smoke detector 122 can be wire coupled, or wirelessly coupled to the regulator 110 utilizing Bluetooth technology.

Advantages of this invention include less chance a driver will have an accident due to the effects of oxygen deprivation or increased levels of carbon dioxide in the vehicle. Also for patients with chronic obstructive pulmonary disease and others that require enhanced oxygen levels, the invention is much more convenient that having an oxygen tank with associated lines for nasal insertion in the vehicle compartment. Additionally, when dust storms hit an area that suffers from them, air quality decreases. Typically, users close all vehicle windows, doors and air vents when a storm hits, essentially sealing the passenger compartment from the outside air. Now, this is effective at keeping the dust and debris out, but reduces the ability for fresh oxygen to enter. Moreover, people that suffer from pulmonary issues, such as asthma, have a greater need to maintain access to clean, fresh oxygen. This invention helps address these issues by providing a source of oxygen easily accessible by the user.

Although the invention has been described in terms of a preferred embodiment, nevertheless, changes and modifications can be made which do not depart from the spirit, scope and teachings of the invention. Such changes and modifications are deemed to fall within the purview of the present invention as claimed.

What is claimed is:

1. A system for providing oxygen in a vehicle passenger cabin, the system comprising:
a) a gaseous oxygen source;
b) a duct for connection to at least one vent for passage of oxygen to the passenger cabin, the duct being coupled to the oxygen source for passage of oxygen from the oxygen source to the vent;
c) a regulator for regulating passage of oxygen from the oxygen source;
d) a controller coupled to the regulator for controlling the regulator; and
e) an oxygen sensor within the passenger cabin and for coupling to the controller for controlling the amount of gas released by the regulator from the oxygen source for passage into the passenger cabin.

2. The system of claim 1, wherein the gaseous oxygen source is a container containing a gas of which at least 90% by volume is oxygen.

3. The system of claim 1, wherein the gaseous oxygen source is an oxygen generating device.

4. The system of claim 1 installed in the vehicle comprising two vents, one vent proximate a driver position and one vent proximate a passenger position, wherein the duct is in gaseous communication with both vents for passage of oxygen from the gaseous oxygen source into the vehicle passenger cabin.

5. The system of claim 1, wherein the regulator is a valve located in the duct.

6. The system of claim 1, wherein the regulator is an off-on regulator, such that when a pre-set lower oxygen level is sensed by the oxygen sensor, the oxygen sensor causes the controller to have the regulator dispense oxygen from the gaseous oxygen source, and when a pre-set upper oxygen level is sensed by the oxygen sensor, the oxygen sensor causes the controller to have the regulator stop dispensing oxygen from the gaseous oxygen source.

7. The system of claim 6, wherein a user can set the pre-set lower oxygen level and the pre-set upper oxygen level using the controller.

8. The system of claim 1, wherein the oxygen sensor has a pre-set lower oxygen level and senses a passenger cabin oxygen level, and the controller is a proportional controller.

9. The system of claim 1, wherein the controller is electrically, pneumatically or wirelessly coupled to the regulator.

10. The system of claim 9, wherein a user can cause the regulator to dispense oxygen from the oxygen source.

11. The system of claim 1, further comprising a smoke detector coupled to the regulator, wherein if the smoke detector detects smoke the smoke detector causes the regulator to stop dispensing oxygen from the oxygen source.

12. A system for providing oxygen in a vehicle passenger cabin, the system comprising:
a) a vehicle having a passenger cabin, an engine compartment, and a trunk;
b) a gaseous oxygen source coupled to the vehicle and not located in the passenger cabin;
c) a duct connected to at least one vent in the passenger cabin, for passage of oxygen to the passenger cabin, the duct being coupled to the oxygen source for passage of oxygen from the oxygen source to the vent;
d) a regulator for regulating passage of oxygen from the oxygen source;
e) a controller coupled to the regulator for controlling the regulator; and
f) an oxygen sensor within the passenger cabin and coupled to the controller for controlling the amount of gas released by the regulator from the oxygen source for passage into the passenger cabin.

13. The system of claim 12, wherein the gaseous oxygen source is located in the engine compartment or the trunk.
